(19) United States
(12) Patent Application Publication
(10) Pub. No.: US 2005/0015159 A1
(43) Pub. Date: Jan. 20, 2005

(54) Electric device system, method of constructing electric device system, computer program and computer-readable recording medium

(75) Inventors: Yuuichi Sakuraba, Tokyo (JP); Yousuke Ishii, Tokyo (JP); Shuuji Yamamoto, Tokyo (JP); Yasutaka Hino, Tokyo (JP); Harumi Wada, Tokyo (JP); Masato Yamaji, Tokyo (JP); Yasuyuki Fujii, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/879,752

(22) Filed: Jun. 30, 2004

(30) Foreign Application Priority Data
Jul. 17, 2003 (JP) 2003-275870

(51) Int. Cl. G05B 11/01

(52) U.S. Cl. 700/17

(57) ABSTRACT

The objects of the present invention are to simplify the construction of the whole electric device system, to avoid cost increase, and to reduce the number of required works even if function updating, performance upgrading, etc. are requested. An electric device system, in which an electric device and a computer system are connected, and an application repository server, which intervenes between the above electric device and the above computer system and is provided with various software program modules as well as provided with panel function modules that construct display functions based on the combination of the above software program modules, is further installed.

### BACKGROUND OF THE INVENTION

1. Field of the Invention

The present invention relates to an electric device system which comprises electric devices including programmable controllers, control devices, data acquisition devices that collect various data, recorders, oscilloscopes, and the like, that operate and monitor apparatuses installed in various industrial processes, production lines in factories, and in various experimental facilities, and a computer system that is connected to these electric devices via communication networks and exchanges various commands and data with the electric devices; a method of constructing an electric devices system; a computer program; and a computer-readable recording medium (hereinafter the recording medium is abbreviated simply as “medium”).

2. Description of the Prior Art

As a bibliography of prior arts relative to an electric device system which comprises various electric devices and a computer system that is connected to these electric devices via communication networks and exchanges commands and data, the one shown below is mentioned.
Gazette for Japanese National Open Patent Application No. 2002-503410
U.S. Pat. No. 5,805,442 Specification

FIG. 1 is a configuration block diagram indicating an example of conventional electric device systems described above.

In FIG. 1, electric device 10 which operates, monitors, and controls devices and acquires data from those devices installed in various industrial processes, production lines in factories, various experimental facilities, etc. is provided with control blocks 11 and web server 12 and further provided with web page files 13 that handle input/output data related to control blocks 11.

Control blocks 11 are the core parts of electric device 10 and operate, monitor, and control devices and acquire data from those devices installed for industrial processes, production lines, various experimental facilities, etc.

Web server 12 is a block provided with ordinal web server functions which are used quite generally.

Web page files 13 are the blocks which fetch data acquired by control blocks 11 and include software program components such as JAVA (registered trademark)(object-oriented programming language made by Sun Microsystems Inc.; hereafter simply called “JAVA”) Applet downloaded to a client and executed.

Electric device 10 as described above is connected to a communication network L such as wired or wireless Internet, Local Area Network LAN or the like, via network interface 14.

In addition, a plurality of such electric devices 10 may also be connected to communication network L.

Computer system 20 is an ordinary client computer system which is provided with display 21 and browsing software 23 and is connected to communication network L via network interface 22.

In these electric device systems, browsing software 23 in client computer system 20 accesses electric device 10 if necessary. This makes electric device 10 download various commands and data in web page files 13 from web server 12 to browsing software 23 via network interface 14, communication network L and network interface 22 located in computer system 20. Browsing software 23 interprets various downloaded commands and data and displays the results in display 21.

More concretely, for example, the following operations are executed: field temperature data acquired by control blocks 11 having temperature measuring functions are transmitted to computer system 20 together with thermometer graphics set in web page files 13, and browsing software 23 receives these various commands and data, and displays thermometer graphics in display 21.

As mentioned above, in conventional electric device systems, computer system 20 implements monitoring of electric device 10 in the form of web page files.

However, in conventional systems as described above, there are the following problems:

Construction of the whole system is troublesome because, in many cases, multiple sets of electric device 10 are installed on communication network L and this necessitates web page files 13 and their accompanying software components to be installed for every set in advance.

In addition, ordinarily electric device 10 has small memory capacity storage and the like, thus introducing a cost increase to store large capacity web page file functions, software program components etc. in large quantities.

Further, when upgrading the contents of web page files 13 and accompanying software program components in response to requests for system function updating and performance upgrading, installation for every set of electric device 10 has to be done one-by-one, and so the number of installation operations becomes tremendously large.

Accordingly, for the above mentioned problems to be solved, the tasks to be achieved by the present invention are to make the construction of the whole system simpler, to avoid cost increase, and to reduce the number of required operations even if function updating, performance upgrading, etc. are requested.

### SUMMARY OF THE INVENTION

The present invention which is designed to achieve these objectives is composed of the following items:

(1) An electric device system, in which an electric device and a computer system are connected, and an application repository server is installed, which intervenes between the above described electric device and computer system and is fitted with various software program modules as well as provided with panel function modules that construct display functions based on the combination of the above software program modules.

(2) An electric device system in accordance with the description of (1), in which the above mentioned electric device is equipped with a configuration file in which arrangements of each of the above software program modules corresponding to each function of the above electric device are described.

(3) An electric device system in accordance with the description of (1), in which the above mentioned computer system downloads the above panel function modules to use them as panel function blocks.

(4) An electric device system in accordance with the description of (1) or (3), in which the above mentioned computer system is provided with a launcher that downloads the above panel function modules to use them as panel function blocks.

(5) An electric device system in accordance with the description of (3) or (4), in which the above mentioned panel function blocks download the above software program modules referring to the above configuration file.

(6) An electric device system in accordance with the description of (2) or (5), in which the above mentioned configuration file describes the information for versions of the above electric device.

(7) An electric device system in accordance with the description of any of (1) to (6), in which the above mentioned computer system executes the above panel function blocks, acquires the data from the above electric device and indicates the statuses of the above electric devices in a display.

(8) An electric device system in accordance with the description of any of (3) to (7), in which the above mentioned computer system stores the above described panel function blocks in the storage.

(9) An electric device system in accordance with the description of (8), in which the above mentioned computer system stores the downloaded above software program modules into the above described storage together with the above panel function blocks.

(10) An electric device system in accordance with any of the description of (1) to (9), in which the above mentioned electric device is configured integrally with the above computer system.

(11) An electric device system in accordance with any of the description of (1) to (10), in which the above described application repository server is installed inside the above computer system.

(12) A method of constructing an electric device system where an electric device is connected to a computer system, in which setting is performed in the above computer system; further comprising the following steps:

(a) a step downloading the panel function modules that construct the display function based on the combination of software program modules,
(b) a step downloading a configuration file in which arrangements of each of the above software program modules corresponding to the above mentioned electric device functions are described, and
(c) a step downloading the above software program modules referring to the above configuration file.
   (13) A method of constructing an electric device system in accordance with the description of (12), in which the above mentioned step (a) is replaced with a launcher.
   (14) A method of constructing an electric device system in accordance with the description of (12) or (13), in which the above mentioned computer system has a step to acquire data from the above electric device and to indicate the status of this electric device in the display.
   (15) A computer program to be executed in a computer system which is connected to an electric device; further comprising the following steps:
(a) a step downloading the panel function modules constructing the display function based on the combination of software program modules,
(b) a step downloading a configuration file in which arrangements of each of the above software program modules corresponding to the above mentioned electric device functions are described, and
(c) a step downloading the above software program modules referring to the above configuration file.
   (16) A computer program in accordance with the description of (15), in which the above mentioned step (a) is replaced with a launcher.
   (17) A computer program in accordance with the description of (15) or (16), in which the above mentioned computer system has a step to acquire data from the above electric device and to indicate the status of the above electric device in the display.
   (18) A computer-readable recording medium in which the computer programs to be executed in a computer system are recorded, the above computer system being connected to an electric device; further recording a computer program having the following steps:
(a) a step downloading the panel function modules constructing the display function based on the combination of software program modules,
(b) a step downloading a configuration file in which arrangements of each of the above software program modules corresponding to the above mentioned electric device functions are described, and
(c) a step downloading the above software program modules referring to the above configuration file.
   (19) A computer-readable recording medium in accordance with the description of (18), in which the above mentioned step (a) is replaced with a launcher.
   (20) A computer-readable recording medium in accordance with the description of (18) or (19), in which the above mentioned computer system has a step to acquire data from the above electric devices and to indicate the status of the above electric device in the display.

### BRIEF DESCRIPTION OF THE DRAWINGS

FIG. 1 is a configuration block diagram of a conventional electric device system.

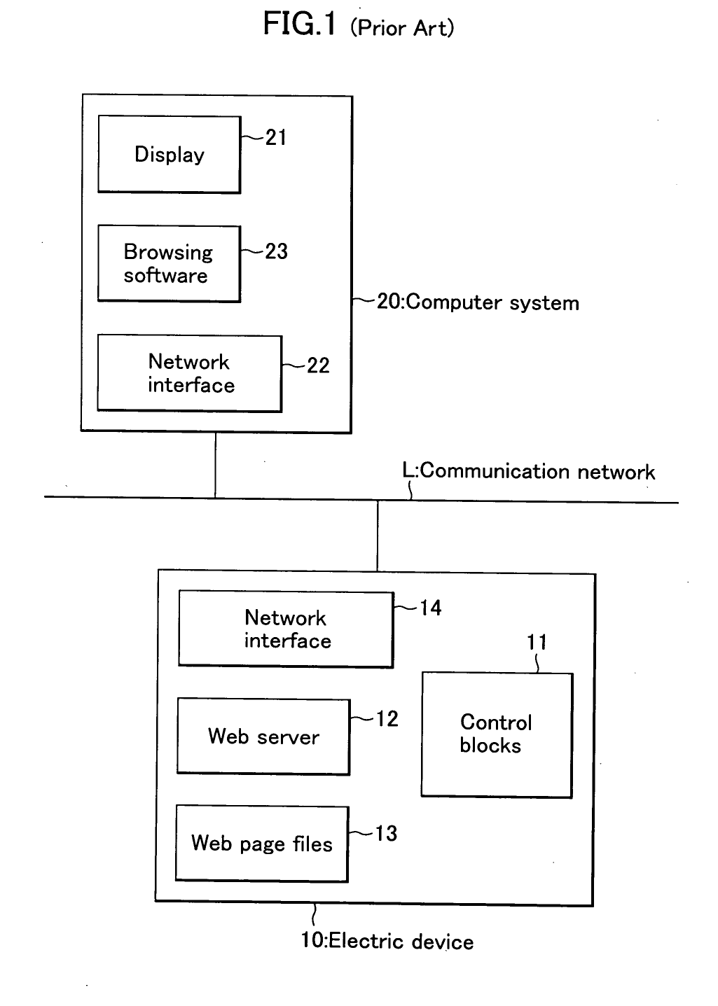

FIG. 2 is a configuration block diagram indicating an embodiment of the present invention.

FIG. 3 is a flow chart representing the operations of the present invention.

FIG. 4 is a block diagram representing an example of installation concerning the present invention.

FIG. 5 is a configuration block diagram indicating another embodiment of the present invention.

### DETAILED DESCRIPTION OF THE PREFERRED EMBODIMENTS

The present invention will be described in detail below using the drawings.

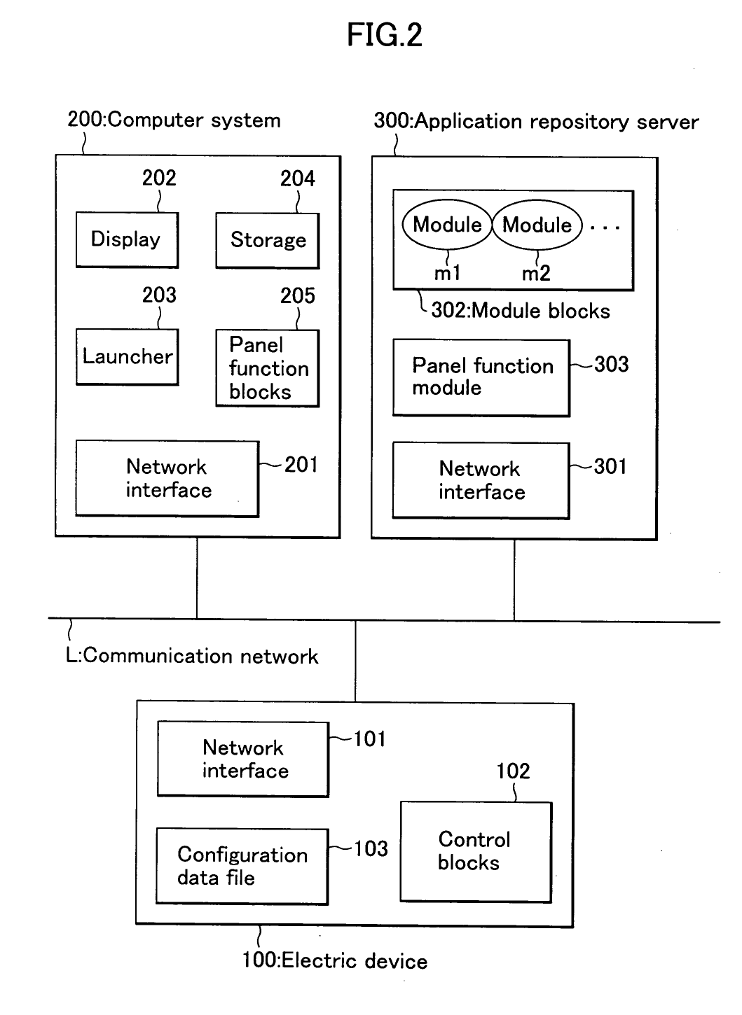

FIG. 2 is a configuration block diagram indicating an embodiment of the present invention.

In FIG. 2, the present invention is composed of a system configured by electric device 100, computer system 200, and application repository server 300, each connected to communication network L.

Electric device 100 is connected to communication network L via network interface 101 and includes, for example, a programmable logic controller, control instrument, data acquisition equipment, oscilloscope, recorder, or the like which performs operation, monitoring, control and data acquisition of devices installed for industrial processes, production lines, etc. Electric device 100 is provided with control blocks 102, the core of electric device 100, and also provided with configuration file 103.

Configuration file 103 is a table-form file in which arrangements of each of the software program modules corresponding to control functions that electric device 100 concerned has, that is, at least IDs (identification numbers and the like) of the software program modules and indicating positions (coordinate values or the like) on the display in computer system 200 described later or the like are described correspondingly.

Concretely, for example, if control block 102 is a block provided with temperature measuring functions, configuration file 103 specifies a software program module that constructs a thermometer graphic or the like and, in addition, specifies software program modules that realize the control function, monitoring function, etc.

Computer system 200 is connected to communication network L via network interface 201 and provided with display 202, launcher 203, and storage 204 that is a memory means and further panel function blocks 205 are downloaded.

In this case, panel function blocks 205 download the required information from application repository server 300 according to configuration file 103 in electric device 100 and form displaying information in computer system 200.

Application repository server 300 is connected to communication network L via network interface 301 and provided with module block 302, that is provided with module m1, module m2, . . . , and, panel function modules 303 which are downloaded to computer system 200 as panel function blocks 205 together with required modules within module block 302.

Hereupon, module m1, module m2 . . . are software program modules including modules related to displaying elements, modules related to data acquisition, modules related to various operations, control actions and monitoring actions and the like, and thus these are modules configured with program command groups only that are not related to data acquired by electric device 100.

To give an example, if electric device 100 is provided with temperature measuring functions, the above modules are the software program modules equivalent to each function corresponding to graphic elements such as thermometer frames, thermometer scales, etc., data acquisition functions handled within control blocks 102, and the like.

Panel function modules 303 are the software program blocks constructing the displaying information, equivalent to conventional web page files. These modules are downloaded to computer system 200 and act as panel function blocks 205.

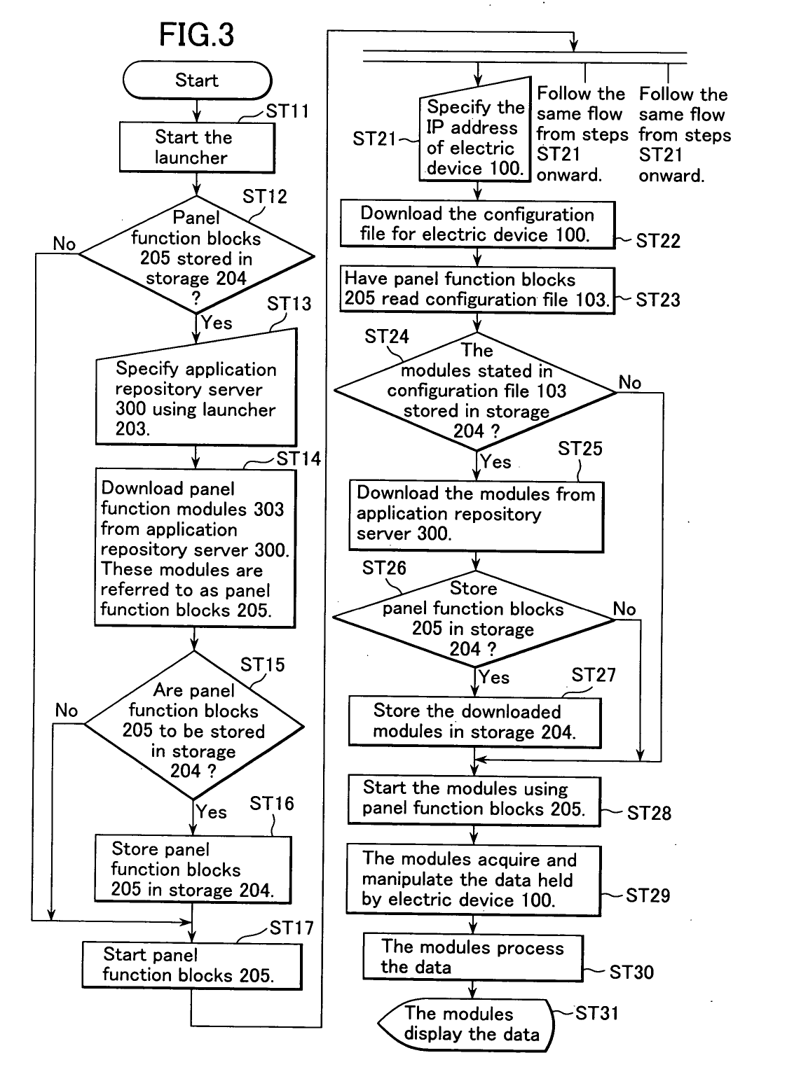

Next, operations of the present invention configured as shown above will be described using the flow chart given in FIG. 3.

In computer system 200, the following procedures are implemented at system start-up to monitor the status of electric device 100 using the web page scheme:

(Step ST11)

Start up launcher 203 indicated in display 202.

(Step ST12)

Check whether panel function blocks 205 are stored in storage 204 of computer system 200.

(Step ST13)

If panel function blocks 205 are not stored in storage 204, specify URL (Uniform Resource Locator) of application repository server 300 to access the server using launcher 203 and ensure connection to network interface 301.

If panel function blocks 205 are stored in storage 204 of computer system 200 in step ST12, jump to step ST17.

(Step ST14)

Next, network interface 201 of computer system 200 downloads panel function modules 303 from network interface 301 via communication network L.

(Step ST15)

Confirm the setting whether downloaded panel function modules 303 are stored in computer system 200 as panel function blocks 205 or not. If setting is that panel function blocks 205 are not stored in storage 204, jump to step ST17 described later without storing panel function blocks 205 in storage 204.

(Step ST16)

If setting is that panel function blocks 205 are stored in storage 204, store them in the above storage 204 in this step.

(Step ST17)

In this status, computer system 200 executes panel function blocks 205. Panel function blocks 205 operate as software programs equivalent to web page construction in computer system 200.

(Step ST21)

Subsequently, launcher 203 specifies the IP address of object electric device 100 and connects the address to network interface 101. In addition, if a plurality of electric device 100 is connected to communication network L, the IP addresses of a plurality of electric device 100 may be specified at the same time and in this case, the same operation as steps subsequent to step ST21 are executed for each of the specified electric devices.

(Step ST22)

Next, network interface 201 of computer system 200 downloads configuration file 103 from network interface 101 of electric device 100.

In configuration file 103, as described before, configuration of each module m1, m2, . . . corresponding to control functions which electric device 100 has, is described in the form of table, list, or map (IDs, display positions, etc.) and in addition, information for versions of electric device 100 and the like are also described.

(Step ST23)

Panel function blocks 205 read downloaded configuration file 103.

(Step ST24)

Panel function blocks 205 check modules m1, m2 . . . to be set in configuration file 103. Modules to be set are assumed to be modules m1 and m2, for example. Panel function blocks 205 check if modules m1 and m2 are stored in storage 204. As the result of the check, if modules m1 and m2 are stored in storage 204, jump to step ST28 described later.

(Step ST25)

If modules m1 and m2 are not stored in storage 204, download modules m1 and m2 from module block 302 in application repository server 300 referring to version information and the like.

(Step ST26)

Panel function blocks 205 confirm the setting if downloaded modules m1 and m2 are stored in storage 204. If the setting is that modules m1 and m2 are not stored in storage 204, jump to step ST28 described later without storing them in storage 204.

(Step ST27)

If the setting is that modules m1 and m2 are stored in storage 204, store them in storage 204 in this step.

(Step ST28)

Subsequently, panel function blocks 205 start up modules m1 and m2 fetched by downloading.

(Step ST29)

Modules m1 and m2 access control blocks 102 in electric device 100 and acquire or operate the required data. The data in this case are transferred from electric device 100 to computer system 200 using the method already known to the public, for example, using FTP (File Transfer Protocol) or the like. That is, only the data acquired by electric device 100 (process data or the like), not the program commands, are transferred from electric device 100 to computer system 200.

(Step ST30)

Subsequently, modules m1 and m2 implement various processing to the data obtained.

(Step ST31)

Modules m1 and m2 indicate the processed data in display 202.

For example, temperature graphics and the like are formed and indicated in display 202. This gives the effect equivalent to monitoring electric device 100 using web page files in computer system 200.

Figuratively speaking, panel function blocks 205 are hereupon the mounts or frames for displaying web page files, and various data or the like processed by modules m1 and m2 are numerical values and graphics embedded in these mounts or frames.

Up to this step, operations at system start-up have been described. However, panel function blocks 205 equipped with modules m1 and m2 downloaded from application repository server 300 are hereinafter stored and saved in storage 204 within computer system 200.

For this reason, from the second operation onward, steps ST12, ST13, ST14, ST15, and ST16 for downloading panel function modules 303 from application repository server 300, and steps ST24, ST25, ST26, and ST27 in which panel function blocks 205 download necessary modules m1 and m2 among the above mentioned actions can be omitted realizing high speed processing.

It is most practical that the present invention as described above is realized as a computer program to be installed in general computer systems.

Also, operability is improved if steps ST12, ST13, ST14, ST15, and ST16, in which panel function modules 303 are downloaded from application repository server 300 to be manipulated as panel function blocks 205, are configured as a launcher like JAVA Web Start Application Manager.

In other words, in general, if JAVA Applet is used, start-up becomes slower because application software is downloaded every time displaying is done in the browser software, but the start-up becomes dramatically faster by utilizing the JAVA Web Start function.

In addition, communication network L connecting computer system 200 with application repository server 300 is the Internet or LAN (Local Area Network).

Furthermore, in electric device 100, it is sufficient to install configuration file 103 and is not necessary to install software program components to be executed originally in a client such as JAVA Applet, Active X, and the like. This enables the storage capacity in electric device 100 to be saved.

In the past, up to now, software program components such as JAVA Applet, Active X and the like, were applied to each electric device. However, by uploading each of the software program elements in application repository server 300, the present invention can deal with this problem, enabling greater efficiency.

Further, if a plurality of electric device 100 connected to communication network L is to be selected, it is sufficient to specify a plurality of IP addresses of relevant electric devices 100 in step ST21. This enables the information from a plurality of electric device 100 to be displayed simultaneously.

Furthermore, it is also acceptable to first start up processing in (step ST21): “Specify the IP address of electric device 100” and (step ST22) “Download the configuration file 103 of electric device 100” and subsequently execute processing in steps ST11, ST12, ST13, ST14, ST15, ST16, and ST17.

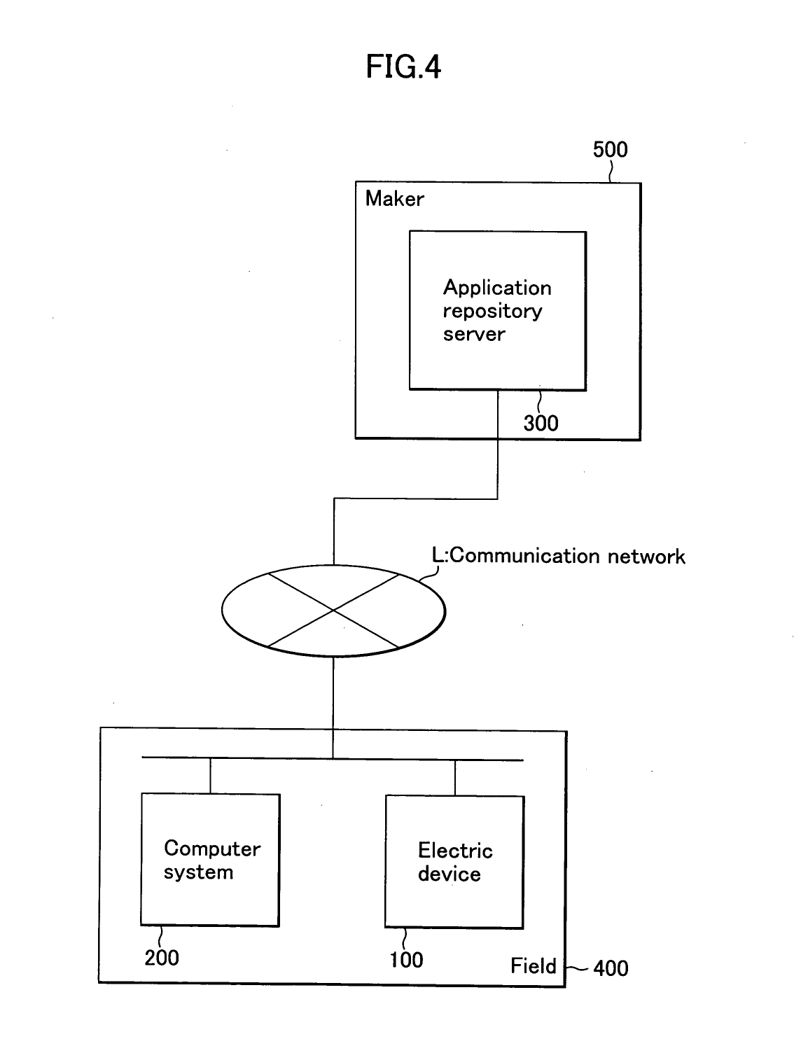

In addition, as shown in FIG. 4, updating services for panel function blocks 205 in computer system 200 and module block 302 in application repository server 300 and the like can be performed at maker 500 via communication network L by installing application repository server 300 in the main office of maker 500 that has developed, manufactured and constructed electric device 100 and/or the whole system (system offerer), not around field 400 (customer) where electric devices 100 and computer system 200 are installed.

Moreover, in the block diagram indicating the configuration of an embodiment shown in FIG. 2 and the operation flow chart shown in FIG. 3, an example of the whole system is presented where three blocks of electric device 100, computer system 200, and application repository server 300 are connected to communication network L. However, device systems where electric device 100 is integrated with computer system 200 are also in the range of the applications of the present invention. That is, connection of application repository server 300 to a device system composed of electric device 100 and computer system 200 via communication network L or a control input/output (I/O) line, can give the same effect as stated above.

An integrated configuration obtained by building the function of application repository server 300 into computer system 200 expressed in the embodiment shown in FIG. 2 may also be employed. In this case, the same effect as described above can also be obtained.

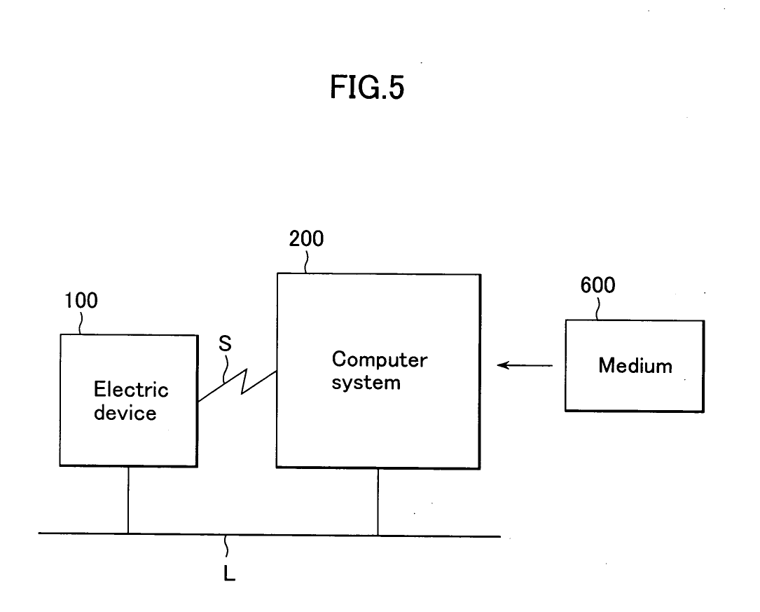

Further, as shown in FIG. 5, it is acceptable to equip computer system 200 with both the function of an ordinary computer system and that of application repository server 300 by setting and installing a medium, for example a CD-ROM, on which the function of application repository server 300 is recorded as a computer-readable computer program, into computer system 200.

In this case, interconnection between computer system 200 and electric device 100 may be made with control I/O line S such as a digital I/O signal line or an analog I/O signal line or the like without using communication network L.

Further, when downloading modules from application repository server 300, accounting may be requested by maker 500 for such downloading.

As described above, the present invention enables easy installation works and function updating works of web page files for monitoring and operating electric devices and accompanying software components, the storage capacity of electric devices can be reduced, resulting in reduced costs.

As apparent from the above description, the present invention has the following effects:

Makes installation and function updating works of web page files for monitoring and operating electric devices and accompanying software components easy, reduces the storage capacity of electric devices, and reduces costs.

1. An electric device system, comprising:
an electric device and a computer system connected to each other; and
an application repository server, which intervenes between said electric device and said computer system and is equipped with software program modules and with panel function modules that construct display functions based on a combination of said software program modules.

2. An electric device system in accordance with claim 1, wherein said electric device is provided with a configuration file in which arrangements of each of said software program modules corresponding to functions of said electric device are described.

3. An electric device system in accordance with claim 1, wherein said computer system downloads said panel function modules to use them as panel function blocks.

4. An electric device system in accordance with claim 1, wherein said computer system is provided with a launcher that downloads said panel function modules to use them as panel function blocks.

5. An electric device system in accordance with claim 3 or claim 4, wherein said panel function blocks download said software program modules referring to said configuration file.

6. An electric device system in accordance with claim 2, wherein said configuration file describes the information for versions of said electric device.

7. An electric device system in accordance with either of claims 3 or 4, wherein said computer system executes said panel function blocks, acquires data from said electric device and indicates a status of said electric device in a display.

8. An electric device system in accordance with either of claims 3 or 4, wherein said computer system stores said panel function blocks in the storage.

9. An electric device system in accordance with claim 8, wherein said computer system stores said downloaded software program modules in said storage together with said panel function blocks.

10. An electric device system in accordance with claim 1, wherein said electric device is configured integrally with said computer system.

11. An electric device system in accordance with claim 1, wherein said application repository server is installed inside said computer system.

12. A method of constructing an electric device system where an electric device is connected to a computer system:
(a) downloading panel function modules that construct a display function based on a combination of software program modules;
(b) downloading a configuration file in which arrangements of each of said software program modules corresponding to functions of said electric device are described; and
(c) downloading said software program modules referring to said configuration file.

13. A method of constructing an electric device system in accordance with claim 12, wherein said step (a) uses a launcher.

14. A method of constructing an electric device system in accordance with claim 12 or 13, wherein said computer system has a step to acquire data from said electric device and to indicate a status of said electric device in a display.

15. A computer program to be executed in a computer system which is connected to an electric system comprising the steps of:
(a) downloading panel function modules constructing a display function based on a combination of software program modules;
(b) downloading a configuration file in which arrangements of each of said software program modules corresponding to functions of said electric device are described; and
(c) downloading said software program modules referring to said configuration file.

16. A computer program in accordance with claim 15, wherein said step (a) uses a launcher.

17. A computer program in accordance with claim 15 or claim 16, wherein said computer system has a step to acquire data from said electric device and to indicate a status of said electric device in a display.

18. A computer-readable recording medium in which the computer programs to be executed in a computer system are recorded, said computer system being connected to an electric device, said medium recording a computer program having the steps of:
(a) downloading panel function modules constructing a display function based on a combination of software program modules;
(b) downloading a configuration file in which arrangements of each of said software program modules corresponding to functions of said electric device are described; and
(c) downloading said software program modules referring to said configuration file.

19. A computer-readable recording medium in accordance with claim 18, in which said step (a) uses a launcher.

20. A computer-readable recording medium in accordance with claim 18 or claim 19, wherein said computer system has a step to acquire data from said electric device and to indicate a status of said electric device in a display.
